(19) United States
(12) Patent Application Publication
(10) Pub. No.: US 2018/0248768 A1
(43) Pub. Date: Aug. 30, 2018

(54) IDENTIFICATION OF MUTUAL INFLUENCE BETWEEN CLOUD NETWORK ENTITIES

(71) Applicant: Intel Corporation, Santa Clara, CA (US)

(72) Inventors: Annie Ibrahim Rana, Dublin (IE); Vincenzo Riccobene, Leixlip (IE); Thijs Metsch, Bruehl (DE); Guiseppe Petralia, Dublin (IE); Joseph Butler, Stamullen (IE); Marcin Spoczynski, Leixlip (IE)

(73) Assignee: Intel Corporation, Santa Clara, CA (US)

(21) Appl. No.: 15/445,598

(22) Filed: Feb. 28, 2017

(51) Int. Cl. H04L 12/24; H04L 29/08; H04L 12/26

(52) U.S. Cl. CPC H04L 41/145; H04L 43/50; H04L 67/10; H04L 41/12

(57) ABSTRACT

Disclosed is a mechanism to identify and quantify influence between data center entities across the physical, allocation, virtual, and service layers. A landscaping system builds an interaction topology. A feature selection mechanism selects metrics that correlate entities connected by the topology. The selected features are then modeled via predictive and inferential modeling techniques. The models generate interaction factors (IFs) that quantify a percentage of a metric for a cloud network entity that is caused by other cloud network entities coupled via the interaction topology. Interaction Confidence Levels (ICLs) are also calculated for the IFs to indicate a level of statistical confidence in the corresponding IF values. The IFs are then employed by a cloud infrastructure management system to optimize allocation of cloud network resources.

### BACKGROUND

Cloud computing technology supports on-demand elastic provisioning of resources for data center tenants. Software applications operate in whole or in part on individual servers in the cloud network. Hence, the software applications consume resources on the server where they are hosted. Such applications, or portions of applications, may be dynamically moved between physical servers at run time in an attempt to match resources to application resource demands, which results in a highly complex system that is difficult to predict and optimize. One optimization problem is the noisy neighbor problem. Resource usage of applications in a cloud network may be dynamic and may change continuously. When resource usage for multiple software applications on the same server spike at the same time, a processing slowdown may occur for all software applications on the server due to momentarily inadequate resources. This simultaneous demand may be referred to as the noisy neighbor problem. The noisy neighbor problem is made more difficult to address because an arbitrarily large number of software applications may be hosted simultaneously in the cloud network. As such, cloud network components may influence each other in a complex and sometimes non-intuitive fashion.

### BRIEF DESCRIPTION OF THE DRAWINGS

The concepts described herein are illustrated by way of example and not by way of limitation in the accompanying figures. For simplicity and clarity of illustration, elements illustrated in the figures are not drawn to scale unless otherwise noted.

FIG. 1 is a schematic diagram of an example of a cloud network.

FIG. 2 is a schematic diagram of an example architecture for a data analytics system.

FIG. 3 is a flowchart of an example method for identifying mutual influence between cloud network entities.

FIG. 4 is a flowchart of an example method for building an interaction topology representing interaction between data center entities.

FIG. 5 is a schematic diagram of a simplified example of an interaction topology.

FIG. 6 is a flowchart of an example method for performing feature selection.

FIG. 7 is a flowchart of an example method for performing prediction modeling.

FIG. 8 is a flowchart of an example method for performing inferential modeling.

FIG. 9 is a schematic diagram of an example network element for use in a cloud network.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, such feature, structure, or characteristic can be employed in connection with another disclosed embodiment whether or not such feature is explicitly described in conjunction with such other disclosed embodiment.

The disclosed embodiments may be implemented, in some cases, in hardware, firmware, software, or any combination thereof. The disclosed embodiments may also be implemented as instructions (e.g. a computer program product) carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Disclosed herein are mechanisms to determine interaction factors (IFs) between cloud network entities. Cloud network entities may include hardware entities (e.g. servers), virtual layer entities (e.g. virtual machines (VMs)), and service layer entities (e.g. service functions). Service layer entities operate on virtual layer entities, which operate on hardware entities. As such, a change in a hardware entity can have an effect on a service layer entity, for example. The IFs indicate the level of interaction between entities across a cloud physical layer, allocation layer, virtual layer, and service layer. The IFs may be employed by a cloud orchestration system when optimizing placement of entities in the cloud network. For example, virtual and service layer entities with high IFs may operate together and hence may be maintained on common hardware, while entities with low or no IFs may be separated with no significant consequence. The IFs are determined by landscaping, feature selection, prediction modeling, and inferential modeling. Landscaping is a process of mapping physical layer entities, allocation layer entities, virtual layer entities, and service layer entities together based on interaction into an interaction topology for analysis. Feature selection is a process of selecting time series of metrics that that correlate entities linked via the interaction topology. Prediction modeling is a process of selecting an appropriate statistical model to model the selected features between the linked entities. Inferential modeling is a process of adjusting model output to accommodate for collinearity and singularity and generating IFs and Interaction Confidence Levels (ICLs) for the adjusted model output. The ICLs indicate the statistical confidence that the IFs correctly describe the interactions and can employed by the cloud orchestration system when performing allocations based on the IFs. For example, the orchestration system may employ the ICLs as a weighting factor or a priority when making resource allocation decisions.

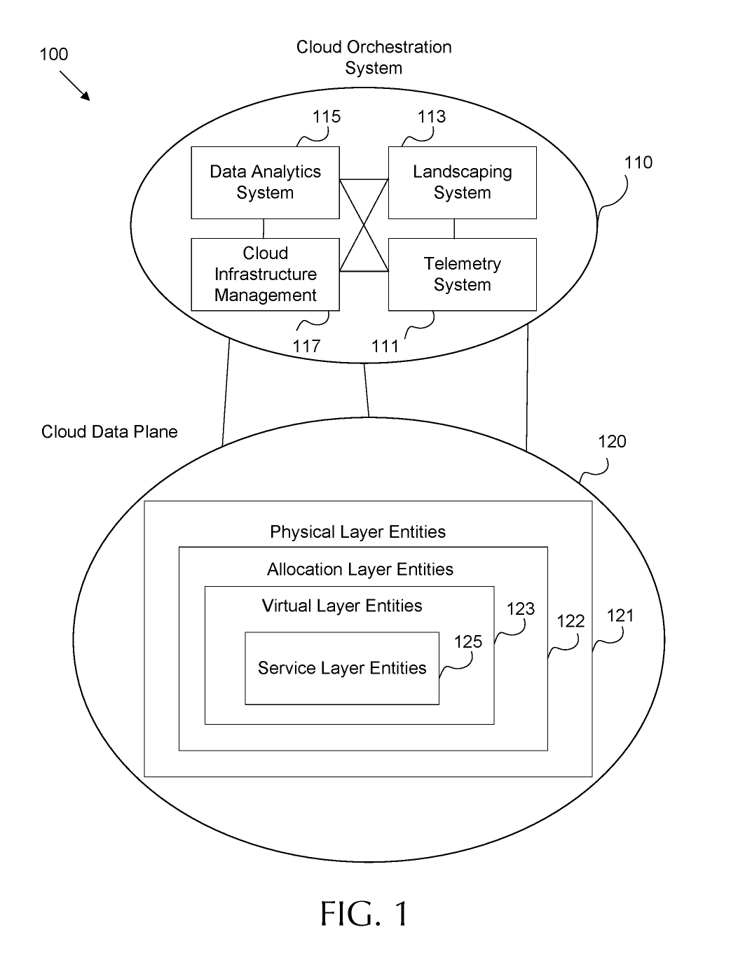

FIG. 1 is a schematic diagram of an example of a cloud network 100, which may be hosted in a data center. The cloud network 100 employs a cloud data plane 120 managed by a cloud orchestration system 110. The cloud data plane 120 includes physical layer entities 121, allocation layer entities 122, virtual layer entities 123, and service layer entities 125. The virtual layer entities 123 and service layer entities 125 may be dynamically reassigned relative to the physical layer entities 121 and allocation layer entities 122 by employing elastic provisioning of hardware resources based computing needs. The cloud orchestration system 110 manages such elastic provisioning by employing a cloud infrastructure management system 117. The cloud infrastructure management system 117 makes provisioning decisions based on input from a telemetry system 111, a landscaping system 113, and a data analytics system 115.

The cloud data plane 120 is a portion of the cloud network 100 for providing network services to tenants and/or end users. Such services may include computing services, security services, storage services, communication services, hosting services, etc. The cloud data plane 120 employs physical layer entities 121, allocation layer entities 122, virtual layer entities 123, and service layer entities 125 to provide these services. The physical layer entities 121 include any cloud network 100 hardware employed to perform physical functions attendant to providing network services. The physical resources 121 may include servers, routers, switches, gateways, Central Processing Units (CPUs), random access memory (RAM), cache, network communication components, long term memory such as read only memory (ROM), etc. Any specified physical resource may be referred to as a physical layer entity 121. The physical layer entities 121 may also be logically divided and/or re-grouped for allocation for different services as allocation layer entities 122. Hence, an allocation layer entity 122 is a logical group of one or more physical layer entities 122. For example, a dis-aggregated group of processors on different servers may be allocated to a single task, creating a dis-aggregated logical server.

The virtual resources 123 are operating environments for services. For example, virtual resources 123 may include VMs, containers, and/or other applications. For example, a hypervisor/operating system (OS) may operate on a specified physical layer entity 121 and/or an allocation layer entity 122. A VM/container may operate on the hypervisor/OS, respectively. Further, the VM/container may be moved to another hypervisor/OS on a different physical layer entity 121 upon demand. A service layer entity 125 is any entity for executing a service and/or process. A service layer entity 125 may operate in the operating environment created by a corresponding virtual layer entity 123, and hence may move between physical layer entities 122/allocation layer entities 122 when the corresponding virtual layer entity 123 moves. For example, a service layer entity 125 may include a virtualized network function (VNF), a load balancer, a firewall, an antivirus service, a video management service, or any other service provided by a cloud network 100. As can be seen, a cloud data plane 120 employing a large number of servers to manage data for a large number of tenants may allocate system resources in an arbitrarily large number of different permutations of physical layer entities 121, allocation layer entities 122, virtual layer entities 123, and service layer entities 125. Many of potential allocations are less efficient than other potential allocations. Hence, optimization of entity allocation increases overall speed and efficiency of the cloud network as well as speed an efficiency of the related entities.

The cloud orchestration system 110 controls entity allocation. As such, the cloud orchestration system 110 operates mechanisms to optimize allocations to increase the speed and efficiency of the cloud data plane 120. The cloud orchestration system 110 employs a telemetry system 111 to monitor the status of the cloud data plane 120. The telemetry system 111 includes sensors and other reporting mechanisms to determine and record the status of the entities over time. For example, the telemetry system 111 may measure a time series of metrics associated with the cloud network entities in the cloud data plane 120 for use in allocation. Such metrics may include measurements or computed values based on measurements. For example, the telemetry system 111 may record such metrics as throughput, latency, power usage, memory space utilization, heat, utilization, quality of service (QoS), etc. It should be noted that many metrics exist to describe the functional state of a cloud network 100. Accordingly, the foregoing list is exemplary but not exhaustive.

The cloud orchestration system 110 employs a landscaping system 113 to determine relationships between entities in the cloud data plane 120 as such relationships change over time due to dynamic provisioning. The landscaping system 113 builds an interaction topology representing interactions between the cloud network entities in the data plane 120 as discussed in more detail below. The cloud orchestration system 110 also employs a data analytics system 115. The data analytics system 115 employs metrics from the telemetry system 111 and the interaction topology from the landscaping system 113 to determine IFs between cloud network entities in the cloud data plane 120 as well as ICLs indicating a level of statistical confidence in the IFs. The data analytics system 115 forwards the IFs and the ICLs to the cloud infrastructure management system 117 to support optimization of the allocation of entities in the cloud data plane 120. The operation of the data analytics system 115 is discussed in greater detail below.

The cloud orchestration system 110 employs the cloud infrastructure management system 117 for employing the IFs for cloud network allocation for the cloud network entities. Specifically, the cloud orchestration system 110 allocates physical layer entities 121, allocation layer entities 122, virtual layer entities 123, and service layer entities 125 in the cloud data plane 120 based on the IFs and ICLs from the data analytics system 115. The cloud infrastructure management system 117 may also consider metrics from the landscaping system 113. The cloud infrastructure management system 117 may make such allocations by co-locating entities with high IFs, separating entities with low IFs, etc. The cloud infrastructure management system 117 may also employ the ICLs to influence such allocations, for example by employing the ICLs as a weighting factor when considering multiple IFs. As another example, the cloud infrastructure management system 117 may prioritized allocations based on IF by giving priority to higher ICLs. IFs and ICLs may be employed in many optimization processes. As such, the foregoing discussion of IFs and ICLs should be considered exemplary and not exclusive.

It should be noted that cloud network 100 is depicted as a greatly simplified diagram for purposes of discussion of the embodiments disclosed herein. One of skill in the art will recognize that cloud network 100 contains many additional components that are not directly relevant to the embodiments discussed herein. Such components may still be desirable for proper operation of cloud network 100. The disclosure should be interpreted as including all such components and/or features as desired to support the operation of the embodiments disclosed herein.

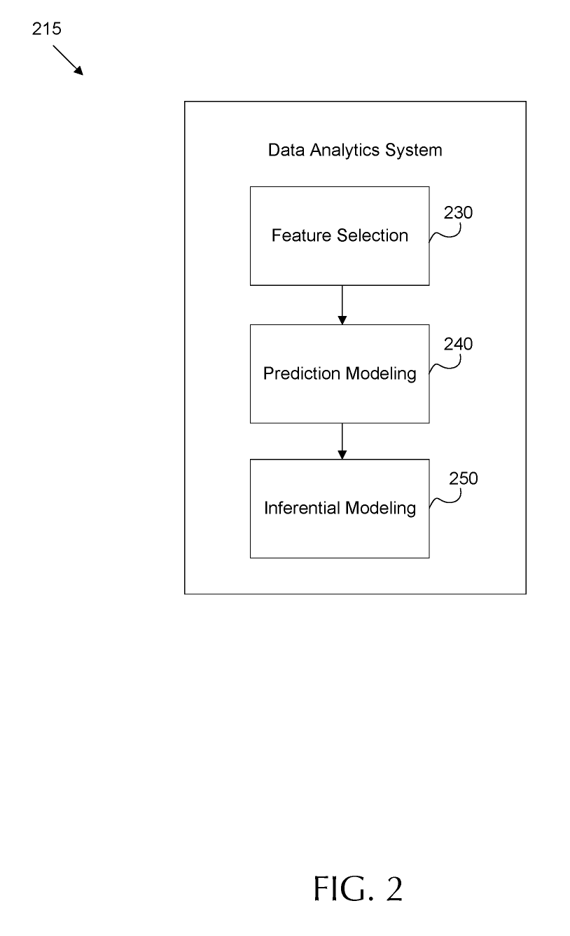

FIG. 2 is a schematic diagram of an example architecture for a data analytics system 215, which may embody a data analytics system 115 in a cloud network 100. The data analytics system 215 generates IFs and ICLs by employing a feature selection system 230, a prediction modeling system 240, and an inferential modeling system 250. The data analytics system 215 may be implemented as a dedicated hardware component or as a sub-system of a cloud orchestration system 100. The data analytics system 215, feature selection system 230, prediction modeling system 240, and/or inferential modeling system 250, may be implemented as individual or combined hardware circuits, such as application specific integrated circuits (ASICs), field programmable gate arrays (FPGAs), firmware modules, software modules, computer program products including executable instructions stored in a memory, or combinations thereof.

The feature selection system 230 is designed to select a set of features from a time series of metrics that describe interactions between the cloud network entities in an interaction topology. In other words, the feature selection system 230 receives an interaction topology from a landscaping system, such as landscaping system 113. The interaction topology describes interactions between cloud network entities in a cloud data plane, such as cloud data plane 120. The feature selection system 230 also obtains time series of metrics for the entities acting as nodes in the interaction topology. The feature selection system 230 iteratively considers each node and all nodes coupled via the interaction topology for correlations. For purposes of discussion, a node under consideration is denoted as node/entity Y and coupled nodes are denoted as nodes/entities X₁-Xₙ. The feature selection system 230 compares the time series for a specified node Y metric to the time series node X metrics to determine correlations. Node X metrics that exhibit a statistically significant correlation with node Y metrics are selected as part of a set of features for further analysis.

The prediction modeling system 240 is designed to perform prediction modeling by employing a selected predictive model of the set of features from the feature selection system 230. In other words, the prediction modeling system 240 receives the set of features exhibiting correlations from the feature selection system 230. The prediction modeling system 240 employs a plurality of regression models to model the time series of metrics in the set of features. The regression models may include simple multiple linear regression, robust multiple linear regression, polynomial regression, etc. The regression models output coefficients and mean (e.g. average) values. The model resulting in the best statistical results, as measured by error values such as regression squared (R²), mean square error (MSE), residual errors, probability (P) values, etc., is selected as the predictive model. The coefficients and mean values for the time series of metrics in the set of features are calculated by the predictive model and forwarded to the inferential modeling system 250. As with the feature selection system 230, the prediction modeling system 240 iteratively selects models and iteratively performs modeling on time series of metrics for the group of coupled nodes X₁-Xₙ with respect to node Y.

The inferential modeling system 250 performs inferential modeling to determine IFs between the cloud network entities based on the selected predictive model of the set of features received from the prediction modeling system 240. In other words, the inferential modeling system 250 receives the coefficients and mean values for the set of selected features, selected by the feature selection system 230, as output by the selected predictive model employed by the prediction modeling system 240. Such coefficients and mean may be skewed by co-linearity and/or singularity. Accordingly, selected features (e.g. including the time series of metrics) that are singular or collinear have their coefficients adjusted to account for such co-linearity and/or singularity. The resulting coefficients and mean values are employed to calculate IFs and ICLs for the IFs. The IFs between the cloud network entities are calculated by the inferential modeling system 250 according to equation 1:

$$IF ( {x}_{i} , y ) = \frac{{ϑ}_{{x}_{i}} * MV ( {x}_{i} )}{MV ( y )} , \qquad Equation 1$$

where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity. ICLs are then calculated for the IFs to determine a confidence level that the corresponding IF provided by the inferential modeling system 250 is correct. The IFs and ICLs may then be forwarded to a cloud infrastructure management system, such as cloud infrastructure management system 117 to support allocation of cloud network entities in the cloud data plane.

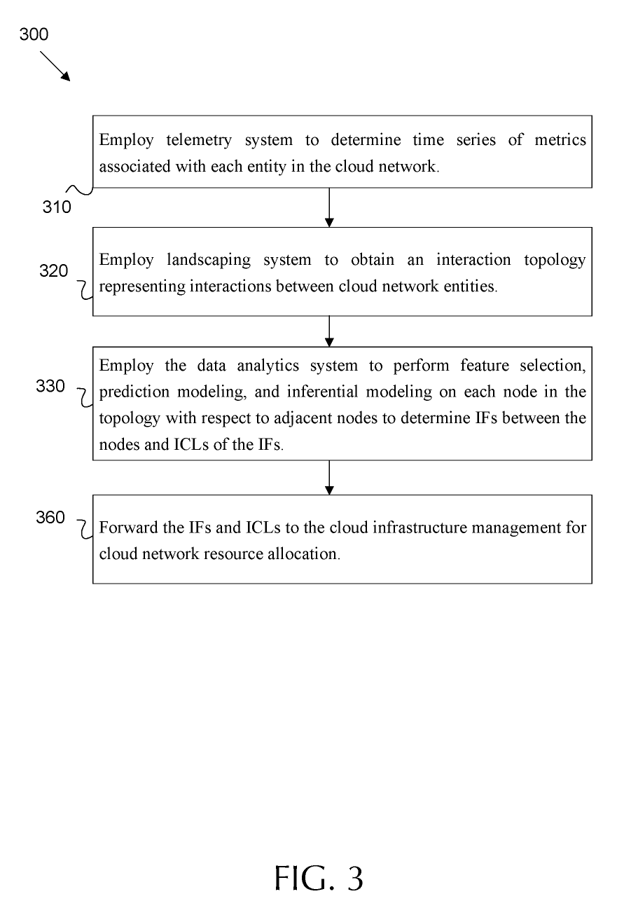

FIG. 3 is a flowchart of an example method 300 for identifying mutual influence between cloud network entities, which can be employed by a cloud orchestration system, such as cloud orchestration system 100 employing a data analytics system 115 and/or 215 to determine interactivity between entities in a cloud network data plane such as cloud data plane 120. Method 300 may operate continuously to continuously optimize the cloud data plane. At block 310, a telemetry system, such as telemetry system 111, is employed to determine various time series of metrics associated with the entities in the cloud network. The metrics may be recorded/computed by various sensors and/or computational devices coupled to the cloud network for monitoring purposes. The metrics are measured over time and hence create a time series (e.g. a series over time). The metrics may vary widely depending on the entity being measured as discussed above. One example of a generally applicable metric is utilization. Utilization indicates the relative percentage of an entities total resources being utilized over a specified time period. Utilization may be calculated according to equation 2:

$${U}_{x}^{{t}_{1} - {t}_{2}} = \frac{{avg ( Throughput )}_{x}^{{t}_{1} - {t}_{2}}}{{Capacity}_{x}} \qquad Equation 2$$

where t₁-t₂ is a time period bounded by a specified start time t₁ and end time t₂, Uₓ^{t}^{₁}^{-t}^{₂} is the utilization of a node X avg(Throughput)ₓ^{t}^{₁}^{-t}^{₂} is the average throughput (e.g. measured resource usage) of the node X over the time period, and Capacityₓ is the maximum allowable resource usage of the node X. As a specific example, block 310 may obtain the utilization node Y and the coupled node(s) X₁-Xₙ as time series of metrics via the utilization system for further analysis. Block 310 may also obtain other time series of metrics relevant to the entities under review. It should be noted that while utilization is discussed above in terms of topological relations, utilization may be calculated for the entities/nodes in the cloud network without first determining an interaction topology.

At block 320, a landscaping system, such as landscaping system 113, is employed to determine, obtain, and/or update an interaction topology representing interactions between cloud network entities in the cloud data plane. The interaction topology indicates relationships between the cloud network entities. The generation of an interaction topology is discussed in greater detail below. At block 330, a data analytics system is employed. The data analytics system performs feature selection on the time series of metrics for a node Y and the corresponding coupled nodes X₁-Xₙ to determine metrics that are correlated and selected such metrics as features. The data analytics system further performs prediction modeling by selecting and employing a selected predictive model of the set of features. Also, the data analytics system performs inferential modeling to compensate for any singularities/collinearities and calculate IFs and ICLs for the IFs based on the selected predictive model. Block 330 may be iteratively employed on each node in the interaction topology with respect to adjacent nodes to determine IFs between the nodes and ICLs of the IFs.

At block 360, the IFs and ICLs are forwarded to a cloud infrastructure management system, such as cloud infrastructure management system 117 for cloud network resource allocation. As such, employing the measured metrics and the interaction topology to calculate IFs and ICLs for the cloud network entities provides information to support the operation of advanced optimization systems. As such, calculating IFs and ICLs supports reorganization of the cloud network, and hence causes the cloud network to operate more quickly and more efficiently (e.g. less hardware needed).

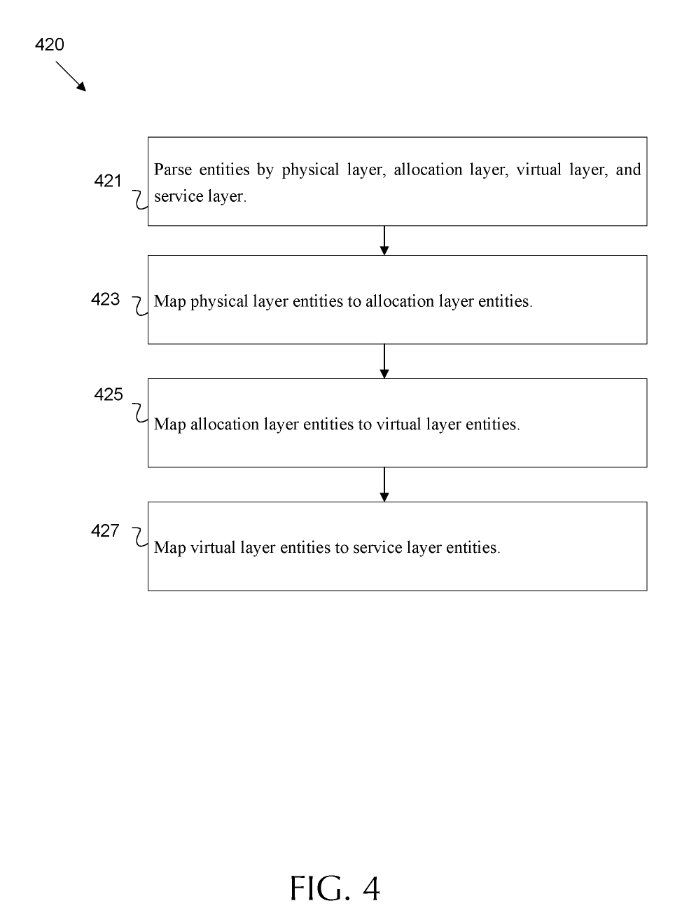

FIG. 4 is a flowchart of an example method 420 for building an interaction topology representing interaction between data center entities. For example, method 420 may be employed by a cloud orchestration system and/or landscaping system such as cloud orchestration system 110 and landscaping system 113, respectively, to implement block 320 of method 300. As noted above, a cloud data plane, such as cloud data plane 120, may contain multiple cloud network entities. For example, the cloud data plane may include physical layer entities (e.g. hardware), allocation layer entities (e.g. hardware groups), virtual layer entities (e.g. operating environments), and service layer entities (e.g. network services), such as physical layer entities 121, allocation layer entities 122, virtual layer entities 123, and service layer entities 125, respectively. Method 420 may be employed to generate an interaction topology that includes cross-layer links indicating interactions across a cloud network physical layer, a cloud network allocation layer, a cloud network virtual layer, and a cloud network services layer.

At block 421, the landscaping system parses the entities in the cloud network by layer. Specifically, the entities are parsed into groups of physical layer, allocation layer, virtual layer, and service layer. Such parsing may be accomplished by querying a database. The database may include data indicating the cloud network entities along with metadata and/or other attributes indicating the layer associated with the entities. The database may also contain operating characteristics and/or capabilities of the cloud network entities as well as relationships between entities. For example, such relationships may include composed of, connected to, deployed on, requires, runs on, depends on, etc.

At block 423, the landscaping system maps the physical layer entities to the allocation layer entities based on the relationships between the entities as stored in the database. At block 425, the allocation layer entities are mapped to the virtual layer entities based on their relationships. At block 427, the virtual layer entities are mapped to the service layer entities based on their relationships. The mappings of the entities according to relationships results in the creation of an interaction topology.

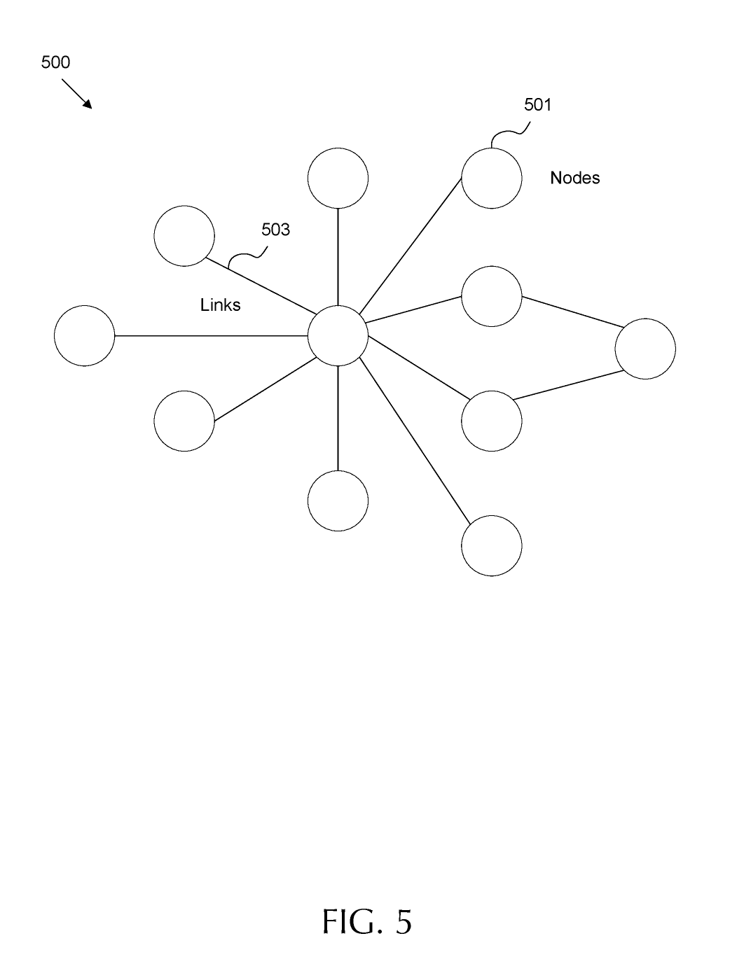

FIG. 5 is a schematic diagram of a simplified example of an interaction topology 500, which may result from method 420. Interaction topology 500 includes nodes 501 and links 503. The nodes 501 indicate particular physical layer entities, allocation layer entities, virtual layer entities, and/or service layer entities. The links 503 indicate interactions between the entities represented by the nodes 501. Such interactions are based on the relationships between the respective entities. Accordingly, an interaction topology 500 may be employed to determine cross-layer links indicating interactions across a cloud network physical layer, a cloud network allocation layer, a cloud network virtual layer, and a cloud network services layer. It should be noted that interaction topology 500 is significantly simplified for purposes of discussion. An operational cloud network employs an arbitrarily large number of entities, and hence an interaction topology 500 for an operational network would include an arbitrarily large number of nodes 501 and corresponding links 503. It should also be noted that the interaction topology 500 is continually updated as the topology of the cloud network dynamically changes based on the computational demands placed on the network. The interaction topology 500 may be forwarded, along with IFs and ICLs, from the landscaping system to a cloud infrastructure management system for optimization of the cloud network. In some embodiments, the IFs may be included with the links 503 (e.g. by a data analytics system) to indicate a strength of the interactions between the associated nodes 501. For visualization purposes, the IF could be depicted as links or varying thickness or color to indicate the strength of the relationship based on a corresponding IF.

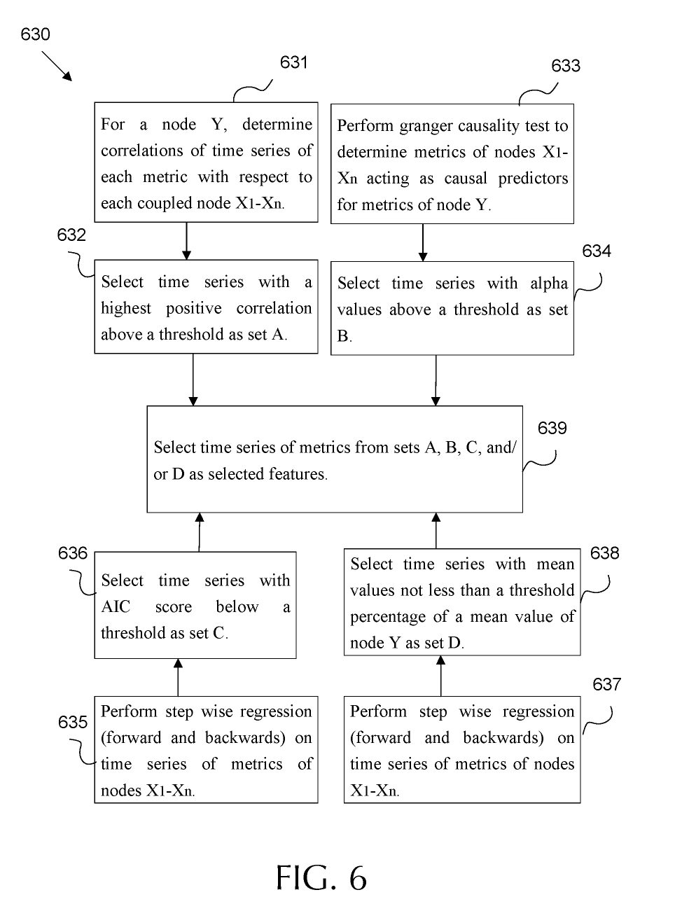

FIG. 6 is a flowchart of an example method 630 for performing feature selection to select a set of features from a time series of metrics that describe interactions between the cloud network entities in an interaction topology such as interaction topology 500 as generated by method 420. In other words, method 630 shortlists features of coupled nodes X₁-Xₙ that may have an impact on a node Y under consideration. For example, method 630 may be employed to implement feature selection in block 330 of method 300 and/or to implement a feature selection system such as feature selection system 230. Method 630 may be applied iteratively to each node in the interaction topology. Accordingly, during each iteration, a node Y under consideration is compared to its coupled nodes X₁-Xₙ. Method 630 may initiate upon receiving time series metrics associated with the cloud network entities Y and X₁-Xₙ. The time series metrics may be received from a telemetry system, such as telemetry system 111, for example as a result of block 310 in method 300.

At block 631, a correlation analysis test is performed on the time series of metrics to determine correlations between the time series for node Y and the time series for coupled nodes X₁-Xₙ. Specifically, the time series of the various metrics associated with node Y are compared to time series of metrics for nodes X₁-Xₙ. The time series compared may be the same metric (e.g. utilization of node Y compared to utilization of node X) or different metrics (e.g. power usage of node Y compared to throughput of node X). At block 632, the time series of metrics of node X showing the highest positive statistical correlation with the time series of metrics of node Y, and vice versa, are selected. A threshold may be employed to allow a user to select a minimum correlation desired to be considered as being included in a set containing the highest correlation. It should be noted that zero, one, or multiple time series of metrics may be selected in block 632. The set of selected time series of metrics can then be saved as selected set A.

Concurrently with blocks 631-632, block 633 performs a granger causality test to compare the metrics of nodes X₁-Xₙ to the metrics of node Y to determine if one or more time series of metrics of nodes X₁-Xₙ can be considered causal predictors of the metrics for node Y. At block 634, the time series of metrics that receive an alpha value in excess of a threshold as a result of the granger causality test (e.g. metric of node X granger causes a metric of node Y) and corresponding node Y metrics are selected as part of a selected set B. As with blocks 631-632, zero, one, or multiple time series of metrics may be selected as the threshold alpha value may be set and/or modified by a user.

Concurrently with blocks 631-634, block 635 performs a stepwise regression analysis on the time series of metrics for nodes X₁-Xₙ to determine which metrics, if any, are predictive of the time series of metrics for node Y. The stepwise regression analysis can be performed by employing forward selection, backward elimination, and/or bidirectional elimination. At block 636, time series of metrics resulting in statistical models with an Akaike Information Criterion (AIC) below a user defined threshold are selected as a set C.

Concurrently with blocks 631-636, block 637 performs stepwise regression in a manner substantially similar to block 635. At block 638, time series with mean values that are less than or equal to a threshold percentage (e.g. ten percent) of the mean value of node Y's metrics, if any, are selected as set D.

At block 639, the time series selected as sets A, B, C, and/or D at blocks 631-638 are selected as selected features. Accordingly, block 639 selects time series of metrics of the coupled cloud network entities that pass some confidence metric under at least one test as the set of features. It should be noted that additional predictive modeling approaches, such as linear regression, polynomial regression, etc., may also be employed as part of method 630 as desired. Taken together, method 630 obtains time series of metrics of coupled cloud network entities X₁-Xₙ directly linked to a specified cloud network entity Y via the interaction topology. The method 630 then performs statistical comparisons via blocks 631-639 to select a set of features to include as time series of metrics of the coupled cloud network entities X₁-Xₙ that statistically correlate to corresponding time series of metrics of the specified cloud network entity Y.

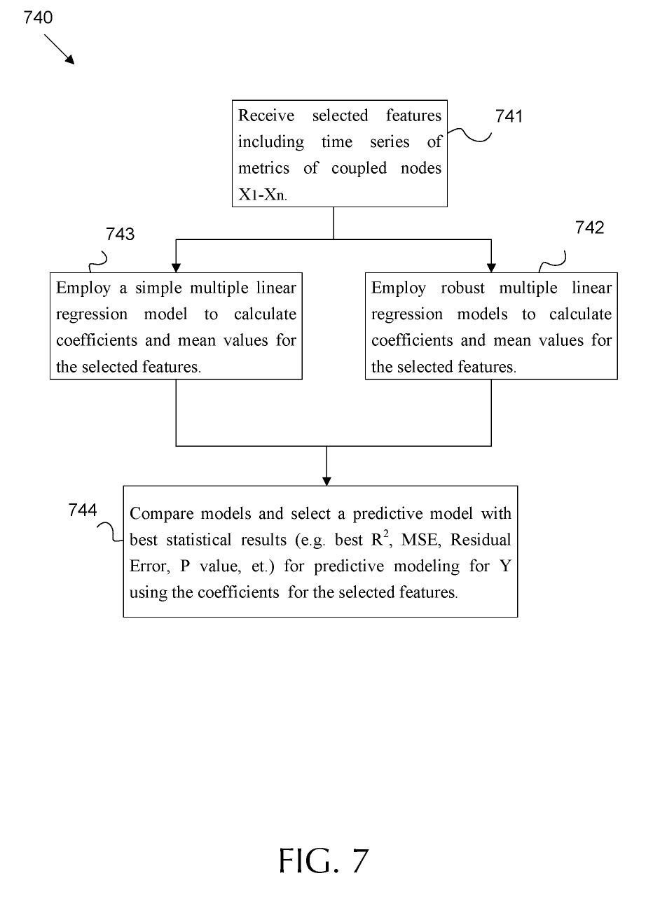

FIG. 7 is a flowchart of an example method 740 for performing prediction modeling to model selected features correlated cloud network entities. In other words, method 740 performs prediction modeling to determine the actual impact of nodes X₁-Xₙ on node Y. For example, method 740 may be employed to implement a prediction modeling system 240 and/or to perform the prediction modeling portion of block 330 of method 300. At block 741, selected features are received, for example as a result of method 630. The selected features include time series of metrics of coupled nodes X₁-Xₙ that statistically correlate to time series metrics of a specified cloud network entity Y. The selected features may be selected as the result of any number of statistical analysis tests.

At block 743, a simple multiple linear regression model is employed to calculate regression coefficients and mean values for the time series of metrics in the set of selected features. At block 742, one or more robust multiple linear regression models are employed to calculate regression coefficients and mean values for the time series of metrics in the set of selected features. At block 744, the models of blocks 742 and 743 are compared for the best statistical results. For example, the models may be compared based on error values such as R², MSE, residual errors, P values, etc. The regression model with the best statistical results, based on statistical results of the multiple regression analysis comparison, is selected as the predictive model. The selected predictive model is employed for modeling the node Y and nodes X₁-Xₙ using the regression coefficients and mean values of the selected features. Accordingly, method 740 selects the most statically valid model for the features selected and then models those features to determine regression coefficients and mean values (e.g. averages) for further analysis.

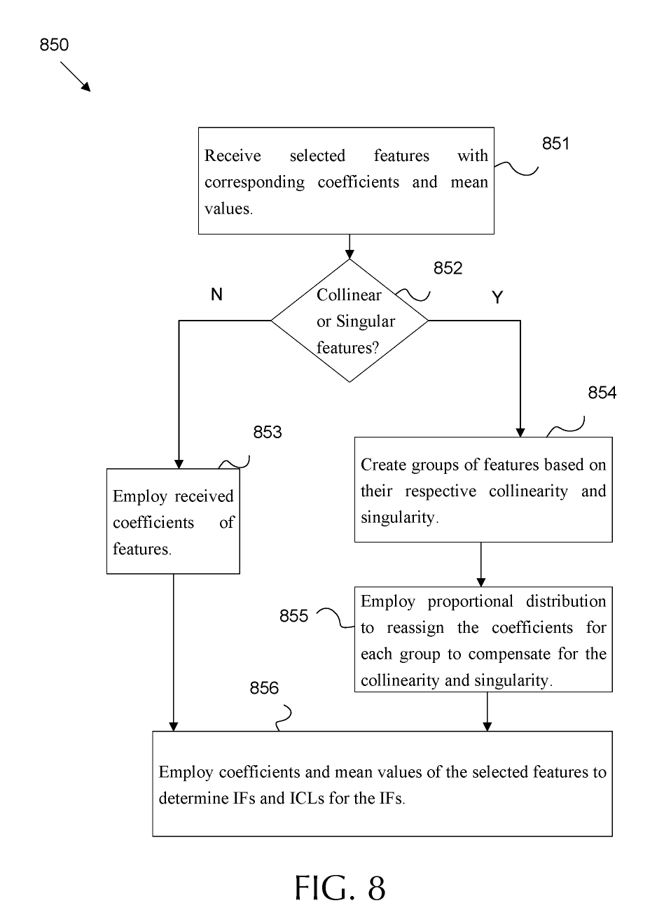

FIG. 8 is a flowchart of an example method 850 for performing inferential modeling to determine IFs and ICLs for the IFs. In other words, method 850 determines IFs to quantify the actual impact of nodes X₁-Xₙ on node Y as determined by method 740. For example, method 850 may be employed to implement an inferential modeling system 250 and/or to perform the inferential modeling portion of block 330 of method 300.

At block 851, selected features are received (e.g. as determined by the feature selection system 230 as a result of method 630) along with corresponding regression coefficients and mean values (e.g. from the prediction modeling system 240 as a result of method 740). At block 852, the selected features are checked for collinearity and singularity. Collinearity occurs when two or more predictor variables in a multiple regression model are highly correlated, meaning that one can be linearly predicted from the others with a substantial degree of accuracy. Collinear predictor variables may be biased due to their correlation causing their predictions to appear more probably that is warranted. Singularities occur when a function describing the predictor variables are discontinuous in some fashion, which can cause in misleading results when the function is considered in its entirety.

The method 850 proceeds to block 853 when there are no collinearities or singularities and employs the regression coefficients and mean values as received at block 851 when proceeding to block 856. The method 850 proceeds to block 854 when there are collinearities or singularities. At block 854, groups of features are created based on their respective collinearity and/or singularity. At block 855, proportional distribution is employed on a group by group basis to reassign the regression coefficients in order to compensation for the associated collinearity or singularity of the groups. This process allows the calculation of a coefficient for singular/collinear metrics, which may not be possible otherwise. In other words, blocks 854-855 adjust regression coefficients of time series in the set of features as desired to compensate for co-linearity and singularity of the time series.

At block 856, the regression coefficients and mean values of the selected features are employed to determine IFs and ICLs for the IFs. The IFs are determined by comparing a regression coefficient and a mean value associated with a time series of a coupled cloud network entity X to a mean value associated with a time series of a specified cloud network entity Y. The IFs between the cloud network entities are calculated according to:

$$IF ( {x}_{i} , y ) = \frac{{ϑ}_{{x}_{i}} * MV ( {x}_{i} )}{MV ( y )} , \qquad Equation 3$$

where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity. An IF between xᵢ and y represents the impact that xᵢ has on y. The IF may be expressed in a range between zero and one. In such a case, zero indicates that zero percent of the values of the relevant metric for y is caused by the corresponding metric for xᵢ. Further, a value of one indicates that one hundred percent of the relevant metric for y is caused by the corresponding metric for xᵢ. Therefore, if the selected features includes all the entities impacting on y, the sum of all IF for all the entities X₁-Xₙ against the specified entity y should be equal to one and/or one hundred percent.

As noted above, the interaction topology indicates interactions between entities operating in different layers. Since the IFs quantify interactions between the nodes of the interaction topology, the IFs also quantify interactions between physical layer entities, allocation layer entities, virtual layer entities, and service layer entities (e.g. physical layer entities 121, allocation layer entities 122, virtual layer entities 123, and service layer entities 125, respectively).

Block 856 also includes determining Interaction Confidence Levels (ICLs) for the IFs to indicate a confidence in the IFs. ICLs represent confidence that the numbers provided by the IF creation algorithm are correct. ICLs may include inference accuracy values, R² values, R² coefficient of determination values, statistical significance values, P values, residual error values, MSE values, or combinations thereof. Upon completion of the calculations, the IFs and ICLs are forwarded to a cloud infrastructure management system to support cloud network allocation for the cloud network entities, for example as part of block 360 of method 300.

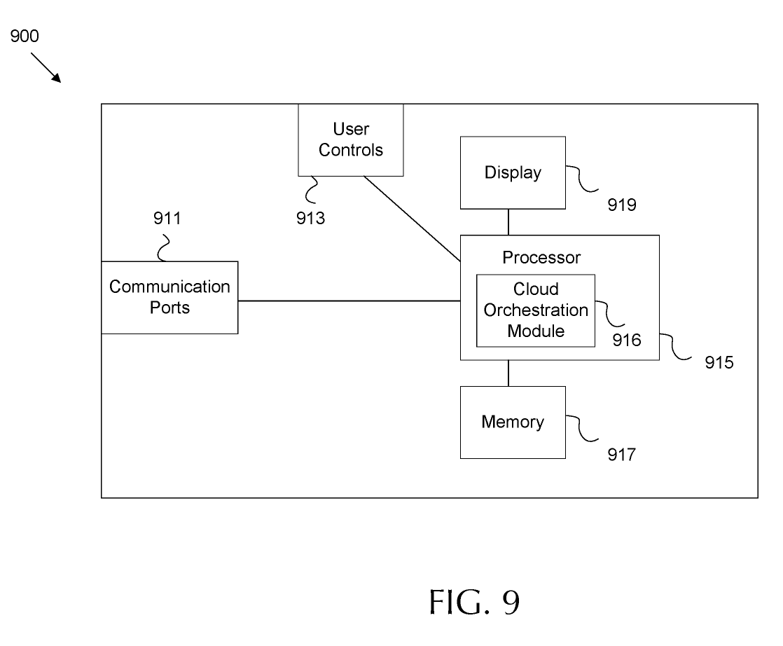

FIG. 9 is a schematic diagram of an example network element 900 for use in a cloud network, such as a cloud orchestration system 110 in a cloud network 100 or an entity in a cloud data plane 120. For example, network element 900 may be employed to implement a telemetry system 111, landscaping system 113, a data analytics system 115 and/or 215, and/or a cloud infrastructure management system 117. Further, network element 900 may be configured to implement a feature selection system 230, a prediction modeling system 240, and inferential modeling system 250, and/or methods 300-800.

Network element 900 includes communication ports 911 which may be any electrical and/or optical ports, etc. configured to accept a communication signal for monitoring and/or control purposes, such as receiving telemetry data, interaction topologies, time series of metrics, selected features, coefficients, mean values, IFs, and/or ICLs, depending on the embodiment. Communication ports 911 may include receivers, transmitters, and/or transceivers. Communications port 911 are coupled to a processor 915, which may be implemented as a general purpose processor, an application specific integrated circuit (ASIC), a digital signal processor (DSP), etc. Processor 915 is configured to execute instructions from memory 917 and may perform any methods and/or associated steps indicated by the instructions. Processor 915 may include a cloud orchestration module 916, which may implement a data analytics system 115 and/or 215 and/or any other portion of the cloud orchestration system 100. The cloud orchestration module 916 may also implement any method disclosed herein. Accordingly, cloud orchestration module 916 may receive telemetry data, employ a landscaping system, employ feature selection, employ prediction modeling, employ inferential modeling to generate IFs and ICLs, and/or employ the IFs and ICLs to perform cloud network resource allocation. In some embodiments, cloud orchestration module 916 may be implemented in whole or in part in memory 917 as well. Memory 917 may be implemented as processor cache, random access memory (RAM), read only memory (ROM), solid state memory, hard disk drive(s), or any other memory type. Memory 917 acts as a non-transitory medium for storing data, computer program products, and other instructions, and providing such data/products/instruction to the processor 915 for computation as needed.

User controls 913 are coupled to the processor 915. User controls 913 may include a keyboard, mouse, trackball, and/or any other controls employable by a user to interact with cloud orchestration module 916 via a graphical user interface on a display 919. Display 919 may be a digital screen, a cathode ray tube based display, or any other monitor to display results of cloud orchestration module 916 to an end user, for example to support altering thresholds, providing allocation instructions, limiting the metrics considered, defining metrics to be considered, etc. However, it should be noted that cloud orchestration module 916 may be disaggregated across multiple hardware systems and/or operated on a dedicated machine. As such, user controls 913 and display 919 directly coupled to processor 915 is optional and presented as an exemplary aspect of the disclosed features.

Aspects disclosed herein may operate on a particularly created hardware, on firmware, digital signal processors, or on a specially programmed general purpose computer including a processor operating according to programmed instructions. The term processor as used herein is intended to include microprocessors, microcomputers, Application Specific Integrated Circuits (ASICs), and dedicated hardware controllers. One or more aspects of the invention may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

### EXAMPLES

Illustrative examples of the technologies disclosed herein are provided below. An embodiment of the technologies may include any one or more, and any combination of, the examples described below.

Example 1 includes a cloud orchestration system for identifying mutual influence between cloud network entities, the system comprising: a landscaping system for building an interaction topology of interactions between the cloud network entities; a telemetry system for measuring time series metrics associated with the cloud network entities; a data analytics system for: selecting a set of features including the time series of metrics that describe interactions between the cloud network entities in the interaction topology; performing prediction modeling by employing a selected predictive model of the set of features; and performing inferential modeling to determine interaction factors (IFs) between the cloud network entities based on the selected predictive model of the set of features; and a cloud infrastructure management system for employing the IFs for cloud network allocation for the cloud network entities.

Example 2 includes the cloud orchestration system of Example 1, wherein the cloud network entities include physical layer entities, allocation layer entities, virtual layer entities, and service layer entities, and the interaction topology includes cross-layer links indicating interactions across a cloud network physical layer, a cloud network allocation layer, a cloud network virtual layer, and a cloud network services layer.

Example 3 includes the cloud orchestration system of Example 2, wherein the IFs quantify interactions between the physical layer entities, allocation layer entities, virtual layer entities, and service layer entities.

Example 4 includes the cloud orchestration system of Examples 1-3, wherein selecting the set of features includes: receiving, from the telemetry system, time series metrics associated with the cloud network entities; obtaining time series of metrics of coupled cloud network entities directly linked to a specified cloud network entity via the interaction topology; and performing statistical comparisons to select the set of features to include as time series of metrics of the coupled cloud network entities that statistically correlate to corresponding time series of metrics of the specified cloud network entity.

Example 5 includes the cloud orchestration system of Example 4, wherein performing statistical comparisons to select the set of features includes: performing a correlation analysis test on the time series of metrics; performing a regression analysis test on the time series of metrics; performing a granger causality test on the time series of metrics; and selecting the time series of metrics of the coupled cloud network entities passing a confidence metric under at least one test as the set of features.

Example 6 includes the cloud orchestration system of Examples 1-5, wherein performing prediction modeling by employing the selected predictive model of the features includes: performing multiple regression analyses on the set of features to calculate regression coefficients and mean values for the time series of metrics in the set of features; and selecting a regression model as the predictive model based on statistical results of the multiple regression analyses.

Example 7 includes the cloud orchestration system of Examples 1-6, wherein performing inferential modeling to determine the IFs includes adjusting regression coefficients of time series in the set of features to compensate for co-linearity and singularity of the time series.

Example 8 includes the cloud orchestration system of Examples 1-7, wherein the IFs are determined by comparing a regression coefficient and a mean value associated with a time series of a coupled cloud network entity to a mean value associated with a time series of a specified cloud network entity.

Example 9 includes the cloud orchestration system of Example 8, wherein the IFs between the cloud network entities are calculated according to:

$$IF ( {x}_{i} , y ) = \frac{{ϑ}_{{x}_{i}} * MV ( {x}_{i} )}{MV ( y )} ,$$

where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity.

Example 10 includes the cloud orchestration system of Examples 1-9, wherein the data analytics system is further for: determining Interaction Confidence Levels (ICLs) for the IFs to indicate a confidence in the IFs; and forwarding the ICLs to cloud infrastructure management system to support cloud network allocation for the cloud network entities.

Example 11 includes a method for identifying mutual influence between cloud network entities, the method comprising: employing a landscaping system to build an interaction topology of interactions between cloud network entities; performing, by a data analytics system, feature selection to select a set of features including time series of metrics describing the interactions between the cloud network entities in the interaction topology; performing prediction modeling by employing a selected predictive model of the set of features; performing inferential modeling to determine interaction factors (IFs) between the cloud network entities based on the selected predictive model of the set of features; and forwarding the IFs to a cloud infrastructure management system for cloud network allocation for the cloud network entities.

Example 12 includes the method of Example 11, wherein the cloud network entities include physical layer entities, allocation layer entities, virtual layer entities, and service layer entities, and the interaction topology includes cross-layer links indicating interactions across a cloud network physical layer, a cloud network allocation layer, a cloud network virtual layer, and a cloud network services layer.

Example 13 includes the method Example 12, wherein the IFs quantify interactions between the physical layer entities, allocation layer entities, virtual layer entities, and service layer entities.

Example 14 includes the method of Examples 11-13, wherein performing feature selection to select the set of features includes: receiving, from a telemetry system, time series metrics associated with the cloud network entities; obtaining time series of metrics of coupled cloud network entities directly linked to a specified cloud network entity via the interaction topology; and performing statistical comparisons to select the set of features to include as time series of metrics of the coupled cloud network entities that statistically correlate to corresponding time series of metrics of the specified cloud network entity.

Example 15 includes the method of Examples 14, wherein performing prediction modeling by employing the selected predictive model of the set of features includes: performing a correlation analysis test on the time series of metrics; performing a regression analysis test on the time series of metrics; performing a granger causality test on the time series of metrics; and selecting the time series of metrics of the coupled cloud network entities passing a confidence metric under at least one test as the set of features.

Example 16 includes the method of Examples 11, wherein performing prediction modeling to select the predictive model includes: performing multiple linear regression analyses on the set of features to calculate regression coefficients and mean values for the time series of metrics in the set of features; and selecting a regression model as the predictive model based on statistical results of the multiple linear regression analyses.

Example 17 includes the method of Examples 11-16, wherein performing inferential modeling to determine the IFs includes adjusting regression coefficients of time series in the set of features to compensate for co-linearity and singularity of the time series.

Example 18 includes the method of Examples 11-17, wherein the IFs are determined by comparing a regression coefficient and a mean value associated with a time series of a coupled cloud network entity to a mean value associated with a time series of a specified cloud network entity.

Example 19 includes the method of Example 18, wherein the IFs between the cloud network entities are calculated according to:

$$IF ( {x}_{i} , y ) = \frac{{ϑ}_{{x}_{i}} * MV ( {x}_{i} )}{MV ( y )} ,$$

where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity.

Example 20 includes the method of Examples 11-19, further comprising: determining Interaction Confidence Levels (ICLs) for the IFs to indicate a confidence in the IFs; and forwarding the ICLs to cloud infrastructure management system to support cloud network allocation for the cloud network entities.

Example 21 includes a non-transitory computer readable medium configured to store a computer program product comprising instructions that, when executed by a processor of a cloud orchestration system, cause the cloud orchestration system to: obtain an interaction topology of interactions between cloud network entities; perform feature selection to select a set of features including time series of metrics describing the interactions between the cloud network entities in the interaction topology; perform prediction modeling by employing a selected predictive model of the set of features; perform inferential modeling to determine interaction factors (IFs) between the cloud network entities based on the selected predictive model of the set of features; and forward the IFs to a cloud infrastructure management system for cloud network allocation for the cloud network entities.

Example 22 includes the non-transitory computer readable medium of Example 21, wherein the cloud network entities include physical layer entities, allocation layer entities, virtual layer entities, and service layer entities, and the interaction topology includes cross-layer links indicating interactions across a cloud network physical layer, a cloud network allocation layer, a cloud network virtual layer, and a cloud network services layer.

Example 23 includes the non-transitory computer readable medium Example 22, wherein the IFs quantify interactions between the physical layer entities, allocation layer entities, virtual layer entities, and service layer entities.

Example 24 includes the non-transitory computer readable medium of Examples 21-23, wherein performing feature selection to select the set of features includes: receiving, from a telemetry system, time series metrics associated with the cloud network entities; obtaining time series of metrics of coupled cloud network entities directly linked to a specified cloud network entity via the interaction topology; and performing statistical comparisons to select the set of features to include as time series of metrics of the coupled cloud network entities that statistically correlate to corresponding time series of metrics of the specified cloud network entity.

Example 25 includes the non-transitory computer readable medium of Example 24, wherein performing prediction modeling by employing the selected predictive model of the set of features includes: performing a correlation analysis test on the time series of metrics; performing a regression analysis test on the time series of metrics; performing a granger causality test on the time series of metrics; and selecting the time series of metrics of the coupled cloud network entities passing a confidence metric under at least one test as the set of features.

Example 26 includes the non-transitory computer readable medium of Examples 21-25, wherein performing prediction modeling to select the predictive model includes: performing multiple linear regression analyses on the set of features to calculate regression coefficients and mean values for the time series of metrics in the set of features; and selecting a regression model as the predictive model based on statistical results of the multiple linear regression analyses.

Example 27 includes the non-transitory computer readable medium of Examples 21-26, wherein performing inferential modeling to determine the IFs includes adjusting regression coefficients of time series in the set of features to compensate for co-linearity and singularity of the time series.

Example 28 includes the non-transitory computer readable medium of Examples 21-27, wherein the IFs are determined by comparing a regression coefficient and a mean value associated with a time series of a coupled cloud network entity to a mean value associated with a time series of a specified cloud network entity.

Example 29 includes the non-transitory computer readable medium of Example 28, wherein the IFs between the cloud network entities are calculated according to:

$$IF ( {x}_{i} , y ) = \frac{{ϑ}_{{x}_{i}} * MV ( {x}_{i} )}{MV ( y )} ,$$

where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity.

Example 30 includes the non-transitory computer readable medium of Examples 21-29, further comprising: determining Interaction Confidence Levels (ICLs) for the IFs to indicate a confidence in the IFs; and forwarding the ICLs to cloud infrastructure management system to support cloud network allocation for the cloud network entities.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Although specific embodiments of the invention have been illustrated and described for purposes of illustration, it will be understood that various modifications may be made without departing from the spirit and scope of the invention. Accordingly, the invention should not be limited except as by the appended claims.

We claim:

1. A cloud orchestration system comprising:
a landscaping system for building an interaction topology of interactions between cloud network entities;
a telemetry system for measuring time series metrics associated with the cloud network entities;
a data analytics system for:
selecting a set of features including the time series of metrics that describe interactions between the cloud network entities in the interaction topology;
performing prediction modeling by employing a selected predictive model of the set of features; and
performing inferential modeling to determine interaction factors (IFs) between the cloud network entities based on the selected predictive model of the set of features; and
a cloud infrastructure management system for employing the IFs for cloud network allocation for the cloud network entities.

2. The cloud orchestration system of claim 1, wherein the cloud network entities include physical layer entities, allocation layer entities, virtual layer entities, and service layer entities, and the interaction topology includes cross-layer links indicating interactions across a cloud network physical layer, a cloud network allocation layer, a cloud network virtual layer, and a cloud network services layer.

3. The cloud orchestration system of claim 2, wherein the IFs quantify interactions between the physical layer entities, allocation layer entities, virtual layer entities, and service layer entities.

4. The cloud orchestration system of claim 1, wherein selecting the set of features includes:
receiving, from the telemetry system, time series metrics associated with the cloud network entities;
obtaining time series of metrics of coupled cloud network entities directly linked to a specified cloud network entity via the interaction topology; and
performing statistical comparisons to select the set of features to include as time series of metrics of the coupled cloud network entities that statistically correlate to corresponding time series of metrics of the specified cloud network entity.

5. The cloud orchestration system of claim 4, wherein performing statistical comparisons to select the set of features includes:
performing a correlation analysis test on the time series of metrics;
performing a regression analysis test on the time series of metrics;
performing a granger causality test on the time series of metrics; and
selecting the time series of metrics of the coupled cloud network entities passing a confidence metric under at least one test as the set of features.

6. The cloud orchestration system of claim 1, wherein performing prediction modeling by employing the selected predictive model of the features includes:
performing multiple regression analyses on the set of features to calculate regression coefficients and mean values for the time series of metrics in the set of features; and
selecting a regression model as the predictive model based on statistical results of the multiple regression analyses.

7. The cloud orchestration system of claim 1, wherein performing inferential modeling to determine the IFs includes adjusting regression coefficients of time series in the set of features to compensate for co-linearity and singularity of the time series.

8. The cloud orchestration system of claim 7, wherein the IFs are determined by comparing a regression coefficient and a mean value associated with a time series of a coupled cloud network entity to a mean value associated with a time series of a specified cloud network entity.

9. The cloud orchestration system of claim 8, wherein the IFs between the cloud network entities are calculated according to:
$$IF ( {x}_{i} , y ) = \frac{{ϑ}_{{x}_{i}} * MV ( {x}_{i} )}{MV ( y )} ,$$
where y is the specified cloud network entity, xᵢ is the coupled cloud network entity interacting with y, IF(xᵢ,y) is the IF indicating a level of interactions between the specified cloud network entity and the coupled cloud network entity, ϑₓ_{ᵢ} is the regression coefficient associated with the time series of the coupled cloud network entity, MV (xᵢ) is the mean value associated with the time series of the coupled cloud network entity, and MV(y) is the mean value associated with the time series of the specified cloud network entity.

10. The cloud orchestration system of claim 8, wherein the data analytics system is further for:
determining Interaction Confidence Levels (ICLs) for the IFs to indicate a confidence in the IFs; and
forwarding the ICLs to cloud infrastructure management system to support cloud network allocation for the cloud network entities.

11. A method comprising:
employing a landscaping system to build an interaction topology of interactions between cloud network entities;
performing, by a data analytics system, feature selection to select a set of features including time series of metrics describing the interactions between the cloud network entities in the interaction topology;
performing prediction modeling by employing a selected predictive model of the set of features;
performing inferential modeling to determine interaction factors (IFs) between the cloud network entities based on the selected predictive model of the set of features; and
forwarding the IFs to a cloud infrastructure management system for cloud network allocation for the cloud network entities.

12. The method of claim 11, wherein the cloud network entities include physical layer entities, allocation layer entities, virtual layer entities, and service layer entities, and the interaction topology includes cross-layer links indicating interactions across a cloud network physical layer, a cloud network allocation layer, a cloud network virtual layer, and a cloud network services layer.

13. The method of claim 12, wherein the IFs quantify interactions between the physical layer entities, allocation layer entities, virtual layer entities, and service layer entities.

14. The method of claim 11, wherein performing feature selection to select the set of features includes:
receiving, from a telemetry system, time series metrics associated with the cloud network entities;
obtaining time series of metrics of coupled cloud network entities directly linked to a specified cloud network entity via the interaction topology; and
performing statistical comparisons to select the set of features to include as time series of metrics of the coupled cloud network entities that statistically correlate to corresponding time series of metrics of the specified cloud network entity.

15. The method of claim 14, wherein performing prediction modeling by employing the selected predictive model of the set of features includes:
performing a correlation analysis test on the time series of metrics;
performing a regression analysis test on the time series of metrics;
performing a granger causality test on the time series of metrics; and
selecting the time series of metrics of the coupled cloud network entities passing a confidence metric under at least one test as the set of features.

16. The method of claim 11, wherein performing prediction modeling to select the predictive model includes:
performing multiple linear regression analyses on the set of features to calculate regression coefficients and mean values for the time series of metrics in the set of features; and
selecting a regression model as the predictive model based on statistical results of the multiple linear regression analyses.

17. The method of claim 11, wherein performing inferential modeling to determine the IFs includes adjusting regression coefficients of time series in the set of features to compensate for co-linearity and singularity of the time series.

18. The method of claim 17, wherein the IFs are determined by comparing a regression coefficient and a mean value associated with a time series of a coupled cloud network entity to a mean value associated with a time series of a specified cloud network entity.

19. The method of claim 17, further comprising determining Interaction Confidence Levels (ICLs) for the IFs to indicate a confidence in the IFs.

20. A non-transitory computer readable medium configured to store a computer program product comprising instructions that, when executed by a processor of a cloud orchestration system, cause the cloud orchestration system to:
obtain an interaction topology of interactions between cloud network entities;
perform feature selection to select a set of features including time series of metrics describing the interactions between the cloud network entities in the interaction topology;
perform prediction modeling by employing a selected predictive model of the set of features;
perform inferential modeling to determine interaction factors (IFs) between the cloud network entities based on the selected predictive model of the set of features; and
forward the IFs to a cloud infrastructure management system for cloud network allocation for the cloud network entities.

21. The non-transitory computer readable medium of claim 20, wherein performing feature selection to select the set of features includes:
receiving, from a telemetry system, time series metrics associated with the cloud network entities;
obtaining time series of metrics of coupled cloud network entities directly linked to a specified cloud network entity via the interaction topology; and
performing statistical comparisons to select the set of features to include as time series of metrics of the coupled cloud network entities that statistically correlate to corresponding time series of metrics of the specified cloud network entity.

22. The non-transitory computer readable medium of claim 20, wherein performing prediction modeling to select the predictive model includes:
performing multiple linear regression analyses on the set of features to calculate regression coefficients and mean values for the time series of metrics in the set of features; and
selecting a regression model as the predictive model based on statistical results of the multiple linear regression analyses.

23. The non-transitory computer readable medium of claim 20, wherein performing inferential modeling to determine the IFs includes adjusting regression coefficients of time series in the set of features to compensate for co-linearity and singularity of the time series.

24. The non-transitory computer readable medium of claim 20, wherein the IFs are determined by comparing a regression coefficient and a mean value associated with a time series of a coupled cloud network entity to a mean value associated with a time series of a specified cloud network entity.

25. The non-transitory computer readable medium of claim 20, wherein the IFs quantify interactions between physical layer entities, allocation layer entities, virtual layer entities, and service layer entities.
